(19) United States
(12) Patent Application Publication
(10) Pub. No.: US 2007/0121338 A1
(43) Pub. Date: May 31, 2007

(54) Light guiding device for vehicle lighting

(76) Inventor: Hsiang-Chen Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/288,183

(22) Filed: Nov. 29, 2005

(51) Int. Cl. F21V 1/00

(52) U.S. Cl. 362/509

(57) ABSTRACT

A light guiding device for vehicle lighting system includes a tube having a serrated surface composed of a plurality of segment surfaces and a reflection member is located beside the serrated surface at a distance. A light source is connected with the tube and emits light beams. The light beams are refracted by the segment surfaces and some of the light beams reflected by the segment surfaces due to narrow input angles will be reflected by the reflection member and travels toward the tube so that the head light has an even illumination with less dark area.

### FIELD OF THE INVENTION

The present invention relates to a vehicle lighting system which includes serrated surfaces and a reflection surface which reflects light that refracted from some of the serrated surfaces so that the light has even illumination.

### BACKGROUND OF THE INVENTION

A conventional vehicle lighting system 3 is shown in FIGS. 1 and 2 and generally includes a light guiding device 1 which includes a tube 11 and a light source 12. The tube 11 is made by transparent material and includes a serrated surface 111 which is composed of a plurality of continuous segment surfaces. A surface 114 is located in front of the serrated surface 111. As shown in FIG. 2, the light beam submitted from the light source 12 moves along a first path 121, a second path 122 and a third path 123, wherein the light beam travels along the first path 121 and refracts into air when passing through the segment surface 112 and then refracts again at another segment surface 113 and travels into the tube 11. Therefore, the light beam along the first path 121 can travel along the serrated surface 11 in the tube 11. When the light beam travels along the second path 122, due to the narrow input angle of the light beam when reaching the segment surface 112, the light beam is total-reflected at the segment surface 112 and towards the surface 114 and goes through the surface 114. When the light beam travels along the third path 123, the light beam goes through the surface 114 via two times of refraction.

However, when a viewer is located in front of the lighting device 3 as shown in FIG. 3, the segment surface 113 looks dark when compared with the segment surface 112 which looks bright, this is because the light beam refracted at the segment surface 113 travels toward the serrated surface 111 rather than the surface 114.

The present invention intends to provide a light guiding device for vehicle lighting system and the light beams can be refracted or reflected forward so that the head light has an even illumination.

### SUMMARY OF THE INVENTION

The present invention relates to a light guiding device for vehicle lighting and comprises a tube with a light source connected therewith and the tube includes a serrated surface composed of a plurality of segment surfaces. A reflection member is located beside the serrated surface at a distance. The light beams emitted from the light source are refracted by the segment surfaces and some of the light beams that are reflected by the segment surfaces are reflected by the reflection member toward the tube so that the light have less dark areas.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a lighting system with a conventional light guiding device;

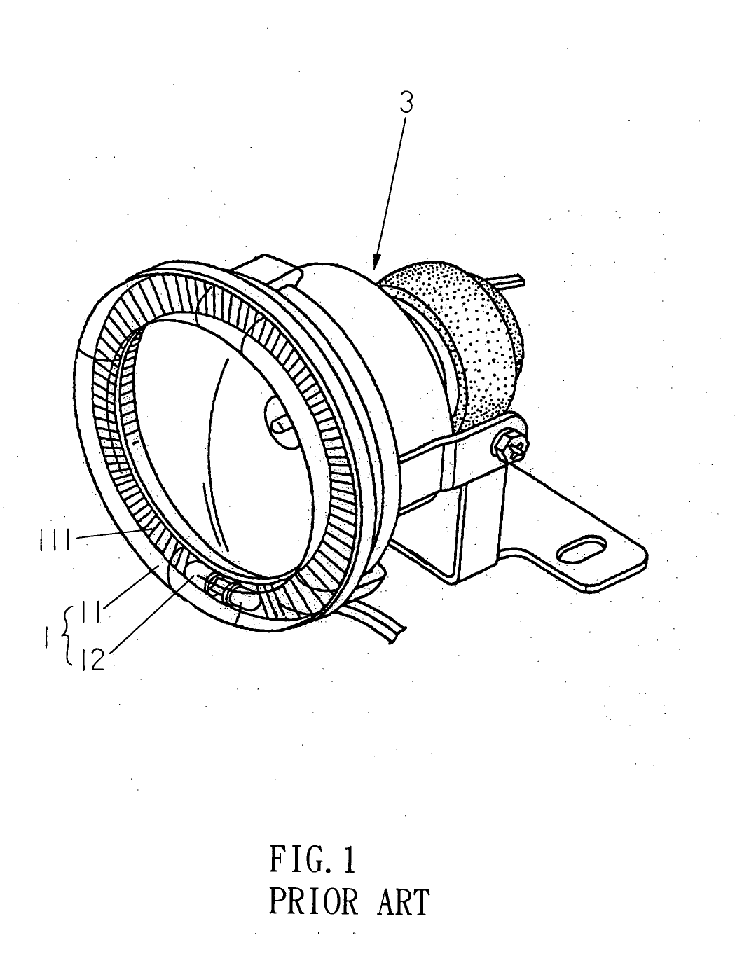

FIG. 2 shows the paths that the light beams travel of the conventional light guiding device;

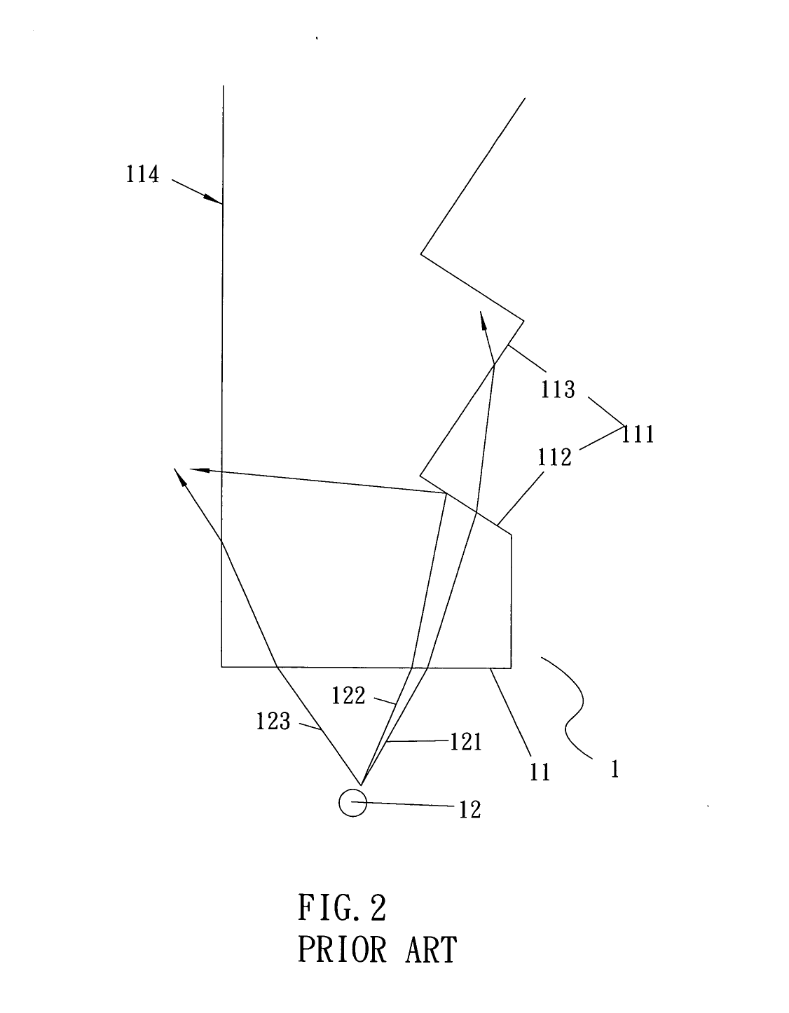

FIG. 3 shows dark area is observed for the conventional light guiding device;

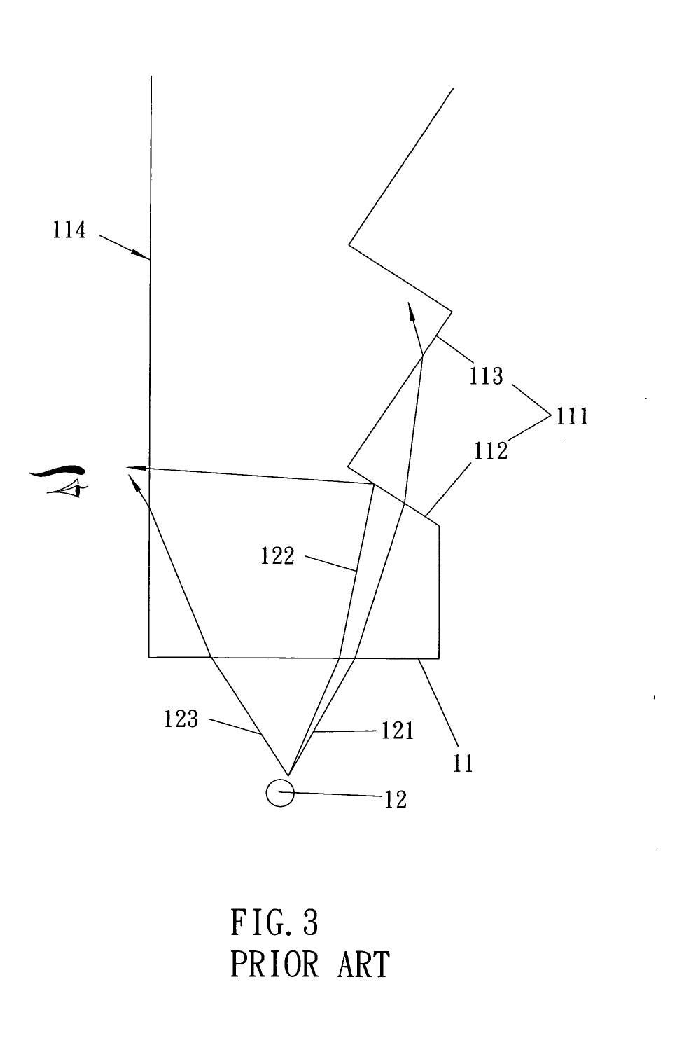

FIG. 4 shows the paths that the light beams travel of the light guiding device of the present invention, and

FIG. 5 shows that less dark area is observed for the light beams travel through the light guiding device of the present invention.

### DETAILED DESCRIPTION OF THE PREFERRED EMBODIMENT

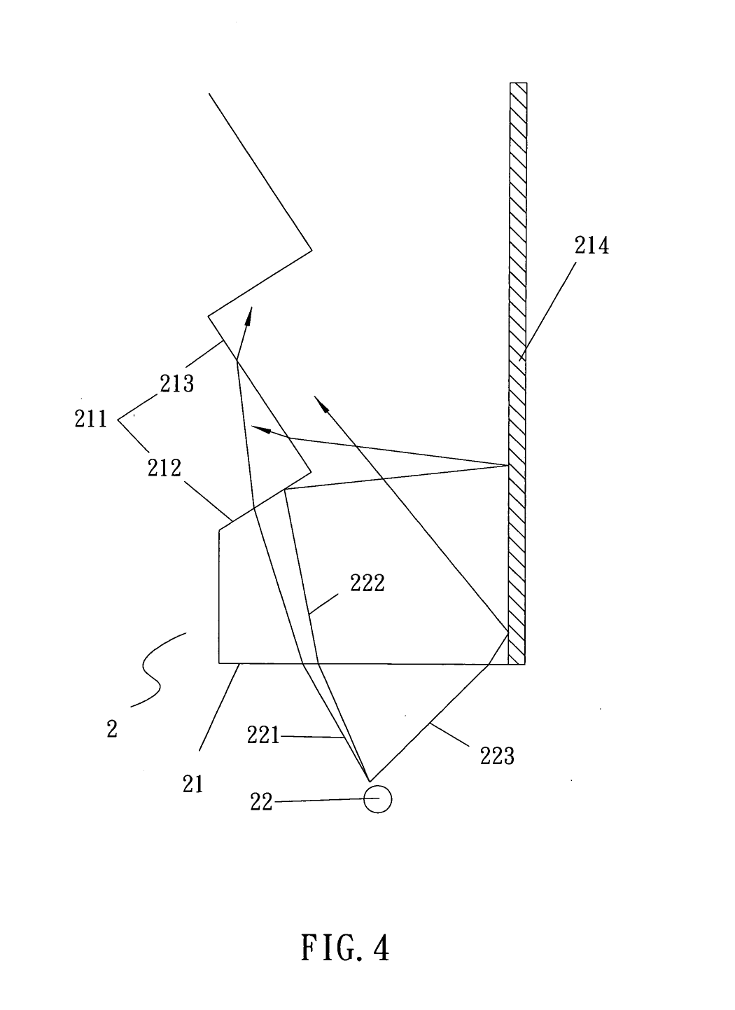

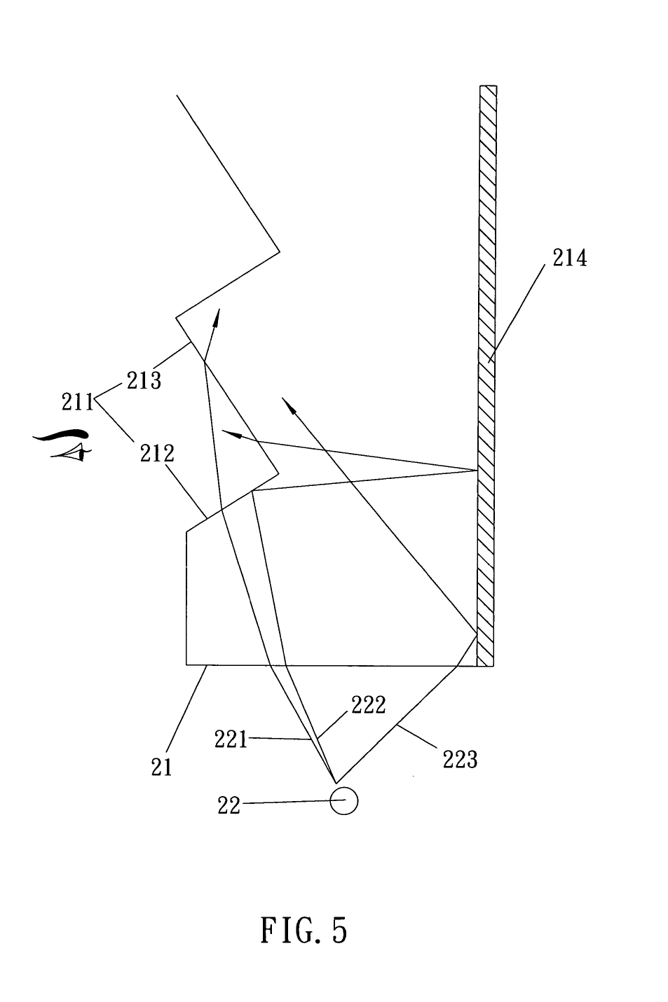

Referring to FIGS. 4 and 5, the light guiding device for vehicle lighting system 2 of the present invention comprises a tube 21 having a serrated surface 211 which is composed of a plurality of segment surfaces 212, 213, and a light source 22 is connected with the tube 21 and emits light beams. A reflection member 214 located beside the serrated surface 211 at a distance. The tube 21 is made of transparent material or any material that the light beams can go through.

The tube 21 with the light source 22 are connected together and the tube 21 is engaged with the lighting system 2 with the serrated surface 211 facing forward. The segment surfaces 212, 213 are located such that the light beams reflected from the segment surfaces 212 or 213 are reflected by the reflection member 214 and travel toward the tube 21.

When the light beam from the light source 22 travels along the first path 221, it refracts at the tube 21 and then refracts again at the segment surface 212 into the air, and then refracts at the segment surface 213 and goes along the serrated surface 211.

The light beam from the light source 22 travels along the second path 222, it refracts at the tube 21 and then reflects at the segment surface 212 because the input angle is too narrow which restricts the light beam to be refracted and the light beam is reflected toward the reflection member 214. The light beam is then reflected toward the serrated surface 211 and goes through the segment surface 213 of the serrated surface 211.

The light beam from the light source 22 travels along the third path 223, it refracts at the tube 21 and then reflects by the reflection member 214 and goes toward the serrated surface 211.

Therefore, for a viewer in front of the head light 2, there will be less dark area because the light beams that are reflected by the segment surface 212 are reflected by the reflection member 214 and travel through the segment surface 213 which looks bright. It is noted that diffusion material can added on the reflection member 214 so as to have a diffusion feature.

While we have shown and described the embodiment in accordance with the present invention, it should be clear to those skilled in the art that further embodiments may be made without departing from the scope of the present invention.

What is claimed is:

1. A light guiding device for vehicle head light, comprising:
a tube having a serrated surface which is composed of a plurality of segment surfaces, a reflection member located beside the serrated surface at a distance, and
a light source connected with the tube and emitting light beams.

2. The device as claimed in claim 1, wherein segment surfaces are located such that the light beams reflected from the segment surfaces are reflected by the reflection member and travel toward the tube.
